(19) United States
(12) Patent Application Publication
(10) Pub. No.: US 2015/0302345 A1
(43) Pub. Date: Oct. 22, 2015

(54) TECHNOLOGY FOR PROJECT SCHEDULING BASED ON TEAM MEMBER STRESS

(71) Applicant: International Business Machines Corporation, Armonk, NY (US)

(72) Inventors: NICHOLAS T. BARTLETT, Chapel Hill, NC (US); CHELSEA C. BEERSE, Cary, NC (US); DAVID J. CLABORN, Raleigh, NC (US); JASON C. GARCOWSKI, Raleigh, NC (US); ANDREW C. LATHAM, Cleveland, OH (US)

(73) Assignee: International Business Machines Corporation, Armonk, NY (US)

(21) Appl. No.: 14/254,123

(22) Filed: Apr. 16, 2014

(51) Int. Cl. G06Q 10/06

(52) U.S. Cl. CPC G06Q 10/063118

(57) ABSTRACT

A project scheduling method includes measuring, by a computer implemented stress level interface, stress levels of project team members during performance of projects. For past projects a relation is determined between project milestone completion times and project team member stress levels. Time required for completion of a current milestone is predicted by applying the current stress levels of the current project team members to the determined relation between milestone completion times and project team member stress levels.

### FIELD OF THE INVENTION

The present invention relates to technology for project scheduling based on team member stress.

### BACKGROUND

A software development cycle calls for project team members to perform certain tasks, where each task is ordinarily assigned a completion deadline. Many times one task cannot begin or fully proceed until one or more other tasks are completed. Consequently, it is important to complete tasks on schedule in order for a software development cycle to progress in a timely manner. However, time to complete a task in software development is often hard to estimate, which contributes to uncertainty about the completion of software projects.

It is known to record progress according to milestones (explained below) and to estimate project completion time by running automated analysis on this data, such as by use of critical path project modeling techniques, for example. As used herein, a project “milestone” refers to a predefined point in a development project, such as a software development project. The predefined point may be an event that receives special attention, such as completion of one or more predefined work packages or other tasks. A milestone may also be defined before such completion, so that examination of the milestone may reveal whether there is a problem, in which case corrective actions can be taken to enable completion on time, or at least more nearly on time.

### SUMMARY

According to an embodiment of the invention, a computer implemented project scheduling method includes measuring, by a computer implemented stress level interface, stress levels of project team members during performance of projects. A computer implemented modeling module determines a relation between project milestone completion times and project team member stress levels for past milestones based on the measured stress levels. A computer implemented module predicts time required for completion of a milestone of the current project by applying the current stress levels of the current project team members to the determined relation between milestone completion times and project team member stress levels.

In another aspect, the method further includes measuring past work rates of past project team members, wherein the relation between milestone completion times and project team member stress levels includes a relation between work rates and project team member stress levels. Applying the current stress levels of the current project team members to the determined relation between milestone completion times and project team member stress levels includes applying the current stress levels of the current project team members to the relation between work rates and project team member stress levels.

In another aspect, the past project team members include the current project team members, or some subset thereof. Determining the relation between project milestone completion times and project team member stress levels includes determining the relation based on stress levels for past projects of the current project team members.

In another aspect, measuring stress levels of project team members during performance of product development projects includes presenting questions about stress levels to project team members and receiving quantitative answers from project team members, wherein the quantitative answers are used for determining the relation between project milestone completion times and project team member stress levels.

In another aspect, the relation indicates relative effects of respective team members on a work rate for the current project.

In another aspect, the method includes determining roles of past project team members and determining for past projects a relation between project milestone completion times and project team member roles.

In another aspect, the method includes determining roles of past project team members and modifying the relation between work rate and stress level for at least one project team member. The modifying is responsive to the role of the at least one project team member.

Other embodiments of the invention are disclosed and claimed, including a computer system implementation and a computer program product.

### BRIEF DESCRIPTION OF DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to embodiments of the invention.

FIG. 2 is an exemplary block diagram of a server apparatus according to embodiments of the invention.

FIG. 3 is an exemplary block diagram of a client apparatus according to embodiments of the invention.

FIG. 4 illustrates an exemplary analysis module to estimate a completion time and determine a confidence level for that estimate, according to embodiments of the invention.

FIG. 5 illustrates aspects of how the analysis module of FIG. 4 determines a team work rate, according to embodiments of the present invention.

FIG. 6A illustrates information measuring, collecting and storing processes, according to embodiments of the present invention.

FIG. 6B illustrates modeling processes, according to embodiments of the present invention.

FIG. 6C illustrates scheduling processes, according to embodiments of the present invention.

### DETAILED DESCRIPTION

In a project, such as a product development effort, embodiments of the present invention enable improved estimating of project completion time, which includes estimating team member contributions by taking into account their stress levels and productivity effects thereof, individually, collectively or both. (Herein, “project” may refer to a group of tasks or even merely a single task.) In this way, adjustments can be made in what work is assigned to what team members, even including which team members are assigned to the overall development effort or to sub-groups within the effort. For example, adjustments can be made to which team members are assigned to work together on a particular milestone. In general, a milestone may present an opportunity to make a decision affecting resource allocation, timing or even a direction of the project, such as features to include or not include in a software product.

In order to predict contributions of current day team members in development projects, history is first collected of observed contributions by the respective current team members on past projects along with other observed factors that may have influenced the contributions at the time, most notably including stress levels of each team member. Observations for other factors may also be collected, including product feature set, available resources, q-cert guidelines, etc.

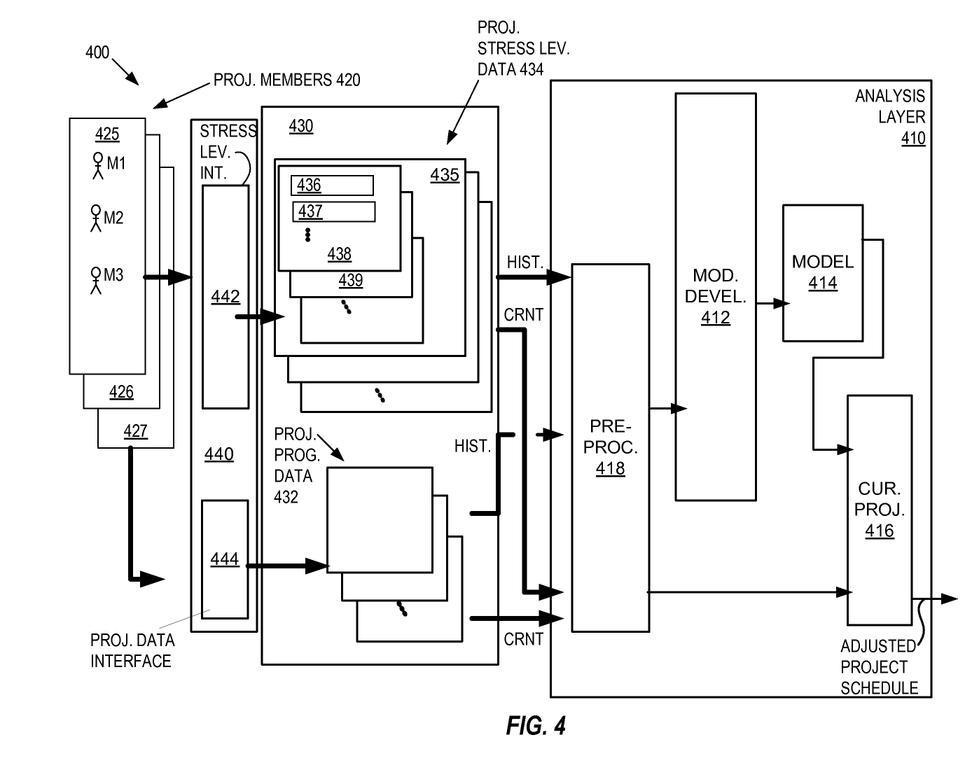

Referring first to FIG. 4, embodiments of the present invention provide system 400 having a data analysis layer 410, which may also be referred to herein as analysis module 410, to estimate a completion time and determine a confidence level for that estimate. This helps to point out potential problems before they arise in order to address on-time delivery of software. In embodiments of the present invention, analysis module 410 looks to stress levels of team members who are developing the project, e.g., a software project. That is, rather than merely utilizing data from the project itself, such as merely project milestone time and progress reports, a model development portion 412 of module 410 quantifies reported team member stress levels for use as a metric in a model 414 of module 410 to determine potential blocks in development, such as potential stress induced inefficiency.

According to embodiments of the present invention, several features cooperate with one another to facilitate on-time delivery of a product or service produced by a project. A front end interface 440 is provided, which includes a stress level user interface (“UI”) 442 that presents stress level questionnaires, by which members 420 of a software development team enter project stress level data regarding their stress. The questionnaires primarily present questions focusing on stress caused by the software development cycle but also allow team members to attribute stress to other causes. Other ways of measuring stress levels are within the scope of embodiments of the present invention and may include biosensor measuring that is communicated for respective team members to interface 442.

Interface 440 communicates with a back end database 430, which organizes and stores data received for team members 420, which includes previously mentioned project stress level data 434 and may include additional project data 432 described herein below. In the illustrated instance, stress level interface 442 receives answers to questionnaires for each one of members M1, M2, etc. who are working on milestones for a first project 425. Interface 442 communicates these to backend database 430, which stores in project stress level data 434 the respective answers regarding project 425 from team member M1 as data 436, 437, etc. for the respective milestones, tagging or otherwise associating milestone related stress level data 436, 437, etc. as data 438 for that team member M1 and, likewise tagging or otherwise associating data 438 for that team member M1 as stress level data 435 for the particular project 425.

Likewise, for each other member M2 on project 425, stress level interface 442 receives answers and communicates these to backend database 430, which stores the respective answers in a similar manner, i.e., as data 439, etc. for each team member M2, etc. for each milestone on project 425, likewise tagging or otherwise associating data 439, etc. for team members M2, etc. as stress level data for the particular project 425 within overall stress level data 434.

Correspondingly for each other project, which may include some of the same team members M1, M2, etc. as project 425 and may include other team members, stress level interface 442 receives answers and communicates these to backend database 430, which stores the respective answers in project stress level data 434 in a similar manner for each team member and each milestone in each project.

Until a milestone is completed, 430 tags the data as data for a current, i.e., pending, milestone of a current project. Once a milestone is completed, 430 tags the data as historic data for the milestone. Likewise, once a project is complete, 430 tags the data as historic data for the project. In this way, system 400 collects current and historical stress level data 434 from respective team members 420 for respective milestones of respective projects 425, etc.

Further, members 420 may enter their respective project roles via stress level interface 442 or, alternatively, via a project data interface 444 that is also provided, either as part of front end user interface 440 or separately. In the depicted instance, project data interface 444 is included in front end interface 440 and team member roles and other data may be entered as project data 432 via project data interface 444 by team members 420 or on their behalf by others.

Such project data 432 may include project scheduling information, including descriptions of project milestones, their planned completion dates, their dependency relations to one another, and their estimated resource requirements, including team member time allocations. Project data 432 may also include time and progress reports, which indicate how much time each team member 420 spent working on each project milestone, when the time was spent, and when each milestone was completed. Time and progress reports may also include measures from team members 420 indicating how much progress has been made toward completion of each milestone before the milestone is actually completed. Both subjective and objective measures may be used.

Regarding project progress and team member contributions, certain terminology is used herein, including the term “work rate,” which refers to an amount of progress toward producing a milestone relative to actual amount of work time spent toward producing the milestone. “Work rate” may also be referred to as an efficiency or productivity factor. Work rate may vary as a function of stress level, according to embodiments of the present invention.

Because stress levels may be subjective and hard to measure, analysis module 410 determines project relevance of respective team member stress levels, which includes assigning weights for use by model 414 in determining actual versus predicted completion time of a milestone or of the overall project. That is, according to embodiments of the present invention, analysis module 410 model development sub-module 412 determines weights for model 414 to apply to each team member's quantified stress level for determining the team's work rate. (Note that a project may, itself, be deemed a milestone. Consequently, references herein to a “completed milestone” may indicate a completed project when the milestone is defined to indicate project completion. Correspondingly, references herein to a “completed project” may be construed to indicate a completed milestone. Further, each milestone may be considered a project, according to at least some embodiments of the present invention.)

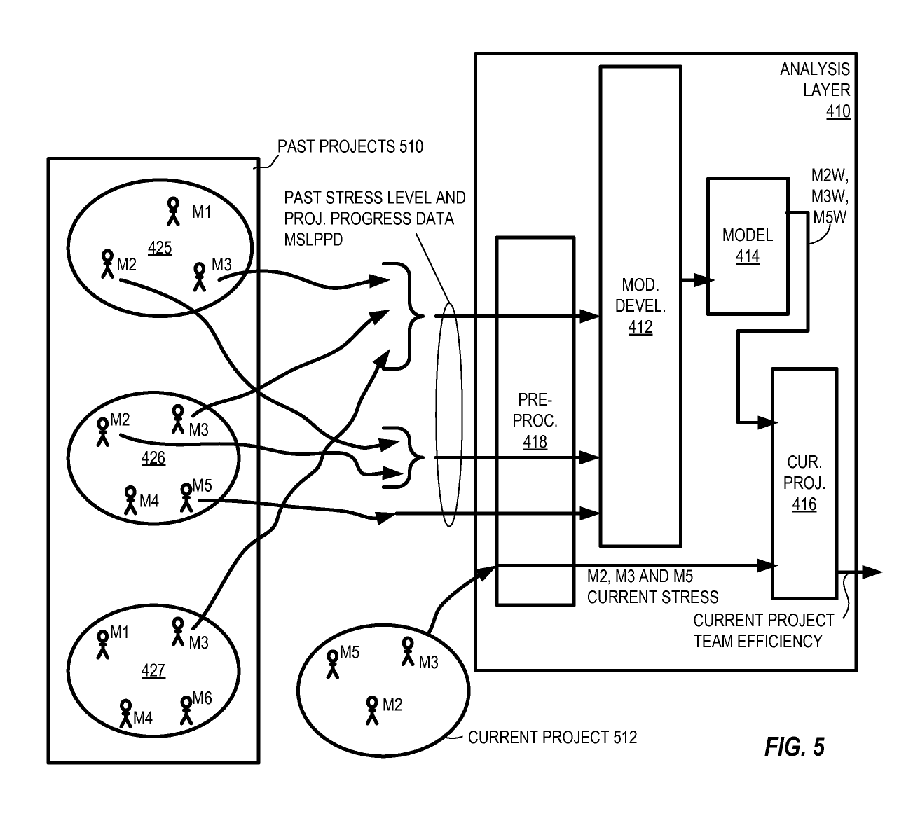

Referring now also to FIG. 5 along with FIG. 4, FIG. 5 illustrates aspects regarding of how system 400 of FIG. 4 determines a team work rate for a current project 512 having team members M2, M3, and M5. In the illustrated instance, historical data has been collected for past projects 510, including a project 425, which had team members M1, M2 and M3, a project 426, which had team members M2-M5, and project 427, which had team members M1, M3, M4 and M6, as shown.

For a model 414, according to one or more embodiments of the present invention, for example, model development module 412 determines a weighting factor for each team member. For example, if increasing stress level tends to decrease work rate for a particular team member, then for this trend, which is an inverse relation between stress and work rate for this team member, model 414 determines a work rate weighting factor that indicates this inverse relation.

Still more specifically, for example, model development module 412 determines a weighting factor for team member M2 from historical stress level and progress data for team member M2 on past projects 425 and 426, i.e., past projects 510 that included team member M2, as described herein. Likewise, model development module 412 determines a weighting factor for team member M3 from historical stress level and progress data for team member M3 on past projects 425, 426 and 427. Finally, model development module 412 determines a weighting factor for team member M5 from historical stress level and progress data for team member M3 on past project 426, since it is the only one of past projects 510 for which team member M5 data was collected.

For a linear model 414 regarding the team of team members M2, M3 and M5 on project 512, according to embodiments of the present invention, collective team work rate=(team member M2 weighting factor×current stress level of team member M2)+(team member M3 weighting factor×current stress level of team member M3)+(team member M5 weighting factor×current stress level of team member M5). Again, stress levels are empirical observations obtained from team members and weights are determined in model development based on historical data, as described herein above, wherein “weights” may also be referred to as model “parameters” or “coefficients.” (The above linear model is just one example. Model development module 412 may generate one or more models 414 having different structures. See description below regarding model structure.)

A current project scheduling module 416 is included in analysis module 410 for predicting completion time of a current project and of milestones for the current project. Having computed a team work rate, module 416 may then predict progress (and corresponding completion time) by applying this overall team work rate to planned, collective work time to be spent by the team of project 512, i.e., predicted progress=predicted team work rate×planned team work time. Correspondingly, module 410 may determine a completion time=current time+predicted progress. A further example is provided herein below illustrating how module 416 of module 410 applies model 414 to predict such completion times.

It should be appreciated that instead of computing an overall team work rate for project 512 and then applying this work rate to work time spent collectively by the team, as described above, module 416 instead may predict progress and corresponding completion time for a milestone by applying individual team member work rates to individual team member working times to predict progress. That is, module 416 may compute a predicted current work rate for team member M2 on current project 512=team member M2 weighting factor (from model 414)×current stress level of team member M2, and then may compute team member M2 predicted progress=team member M2 work rate×team member M2 planned work time, and likewise for team members M3 and M5. Module 416 may then sum the predicted progress of the individual team members to determine the overall predicted progress.

Model development module 412 may adjust weights via an intelligent learning process based on project data 432 and stress level data 434 acquired over time. Thus, embodiments of the present invention provide not only a stress level metric for project schedule related analysis, but they also learn from input and results, wherein sub-module 412 changes parameters of model 414 over time to provide more accurate results. Sub-module 412 may even change the structure of model 414 over time. This ensures more accurate project completion estimates as well as earlier warnings signs of an impending schedule issue.

Analysis module 410 is provided for running analytics on data 434 and 432, as previously stated. In another aspect, according to one or more embodiments of the present invention, module 410 may determine a percentage of team members 420 whose stress levels exceed a certain threshold and may factor this into its analysis for predicting work rate, which may include individual work rates of the respective team members, an overall work rate for the overall team, a work rate for a subset of team members who are working on a particular milestone, or any combination thereof.

Roles are important in determining who should be assigned what work according to their expertise and responsibilities. Further, analysis module 410 may also factor in importance to the team of project 425, etc. of each member M1, M2, etc. based on historic data 432 and 434, including job position, i.e., role, within a sub-team or within an overall project team. Thus, roles may be included as parameters in model 414. For example, module 412 may modify a team member's work rate weighting factor responsive to the team member's role, which may include increasing or decreasing the team member's predicted work rate weighting factor, depending on which effect the role has historically tended to have. This may also include directly adding or subtracting from the team work rate, rather than modifying the team member's predicted work rate weighting factor.

Aside from reported roles, intelligent system 400 learns who are key members of a particular team 425, etc. by evaluating past projects and how the reported stress of each member M1, M2, etc. affected work rates and completion times for milestones of that particular project. By factoring this in, system 400 learns about team members and more accurately estimates project completion. After running these analytics on data 434 and 432, analysis module 410 then provides its estimates along with a confidence level for the results. After analyzing enough historical data 434 and 432, and responsively revising model 414, system 400 is able to predict complications in a software development cycle by properly identifying the significance of particular stress levels and rules for particular team members before a project schedule is unduly affected. This adds a predictive component to system 400 that other project scheduling systems lack.

### USE CASE EXAMPLES

### Example 1

Manager Billie Jean is having issues with determining how long her team will take to complete different tasks. Unbeknownst to her, two of the members of her team have extremely high stress levels. However, system 400 recognizes these factors and sends a report to Ms. Jean, along with a suggested course of action for re-organizing the work items assigned to each of her team members so that impact on project schedule can be reduced. This may include changing what work items are assigned to which existing team members, adding team members, moving team members from one project or milestone to another, changing timing of the project, or changing features to include in the software product. A user may use module 416 to manually determine one or more suggested course of action by applying model 414 to hypothetical cases in which these various changes are posited. According to embodiments of the present invention, model 416 automatically generates such hypothetical changes and thereby generates one or more suggested course of action.

### Example 2

Chelsea is really stressed. She actually performs better at high stress levels, unlike Brittany. System 400 recognizes this from data it has gathered about progress Chelsea makes during high-stress level periods of her past project work. Accordingly, system 400 recommends assigning some of Brittany's work items in the current project to Chelsea when it determines Brittany's stress is likely to negatively affect her work rate to a significant degree.

As previously mentioned, module 412 may generate different types of models 414. Module 412 is configured to provide model identification that functions to select model terms for inclusion in model 414, determine model structure, and estimate model parameters. Module 412 is configured to evaluate effectiveness of each model 414 to account for variations in work rates or completion times and select which model to use accordingly. Other factors may also affect what type of model 414 chooses.

The structure of models 414 generated by module 412 may vary according to embodiments of the present invention, and may include among others neural network and regression based models, both of which include parameters that are adjusted to more optimally fit each model to relationships that the model seeks to describe, where the relationships tend to be revealed by the historical data. If modeling is done by a neural network, the adjustment of parameters is usually called “training.” For a regression type of model structure, it is common to refer to adjustment of parameters as “curve fitting.” Herein, the term “learning” is intended to include training, curve fitting or both.

As previously stated, a current project scheduling module 416 is included in analysis module 410 for predicting completion time of a current project and of milestones for the current project. To predict a completion time for a milestone, for example, preprocessor module 418 first receives a user request to perform scheduling operations for a current project, which the user identifies to module 418, including the milestone of interest. Preprocessor module 418 responsively finds, in project progress data 432, team members who are assigned to the identified milestone for the identified current project and then finds current stress level data 434 for those identified team members and provides it to module 416, which in turn applies the received data for the respective team members and milestone to model 414.

Returning to the meaning of “work rate,” as the term is used herein, in an example in which work time is measured in work hours, if a planned total amount of work time required to produce a milestone is 120 standard working hours and the actual working hours spent to produce the milestone is 120 hours, then the work rate is 120 standard hours/120 actual hours spent=1 hour of progress per hour of work time spent, i.e., 100% efficiency. If the planned total amount of work time required to produce a milestone is 120 standard hours and the actual working hours actually spent to produce the milestone is 100 hours, then the work rate is 120/100=1.2 hour of progress per hour of work time, i.e., 120% efficiency. If the planned total amount of standard work time required to produce a milestone is 120 hours and the actual working hours spent toward producing the milestone is 96 hours, then the work rate is 96/120=0.8 hour of progress per hour of work time, i.e., 80% efficiency.

On the above described basis, when work time is expressed in hours, module 416 may predict work time required for completion of a milestone as work rate x estimated number of standard work hours required for completion, where work rate for a team may be computed by applying current team member stress levels to model 414, such as described herein above for linear model, for example.

Correspondingly, for work time measured in work days, a predicted number of work days required for completion of a milestone=work rate×estimated number of standard work hours required for completion of milestone/number of work hours to be provided per day. Accordingly, module 416 may compute a predicted completion date, wherein predicted completion date=current date+number of predicted work days required for completion of milestone+number of nonworking days.

It should be understood that in general usage a predicted “completion time” may refer to either work time required for completion or may refer to a time when completion will occur, such as a particular calendar date. It should be understood from the above that determination of either kind of “completion time” is enabled by determining a work rate as disclosed herein and by applying that rate to an estimated number of standard work time units that are required for completing the milestone, such as working hours, according to the appropriate formula described herein above.

It should be appreciated from the foregoing that a predicted number of work days required for completion of a milestone may be reduced, which will yield an earlier completion date, either by increasing the number of work hours provided per day, such as by having team members work more hours per day or by adding more team members working toward the milestone, as is conventional. However, days to completion may also be reduced by improving individual or team work rates, which may be facilitated in ways that are disclosed herein.

As previously stated, module 412 is configured to evaluate effectiveness of each model 414 to account for variations in work rates or completion times and select which model to use accordingly. Evaluating effectiveness may include determining a quantitative goodness of fit of a model 414. According to embodiments of the present invention, module 416 may apply the goodness of fit indication to a predicted completion time, or may apply a factor derived therefrom, in order to provide a time range and a degree of confidence indication for the range.

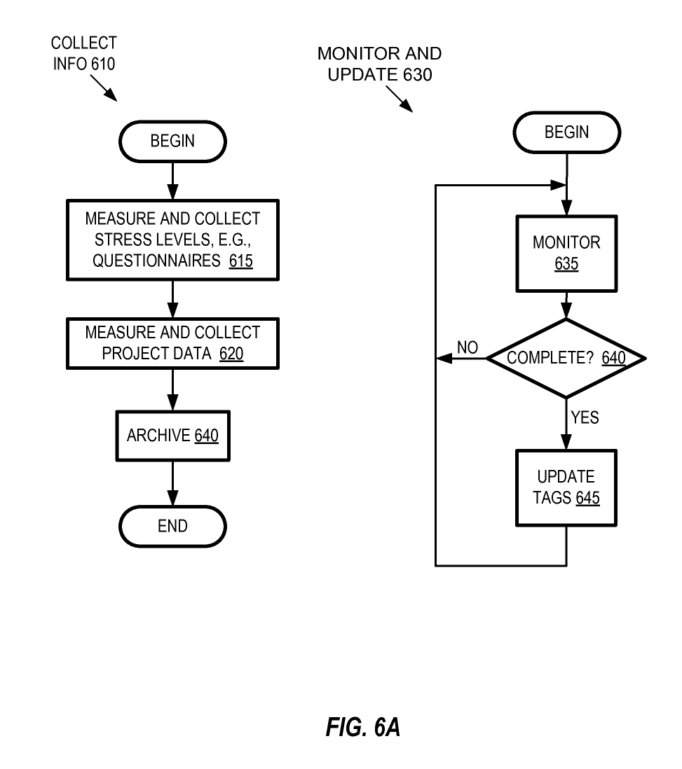

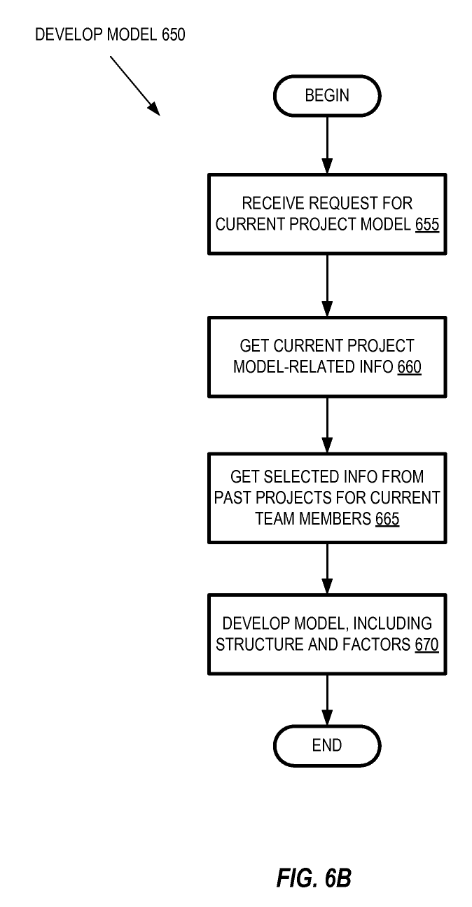

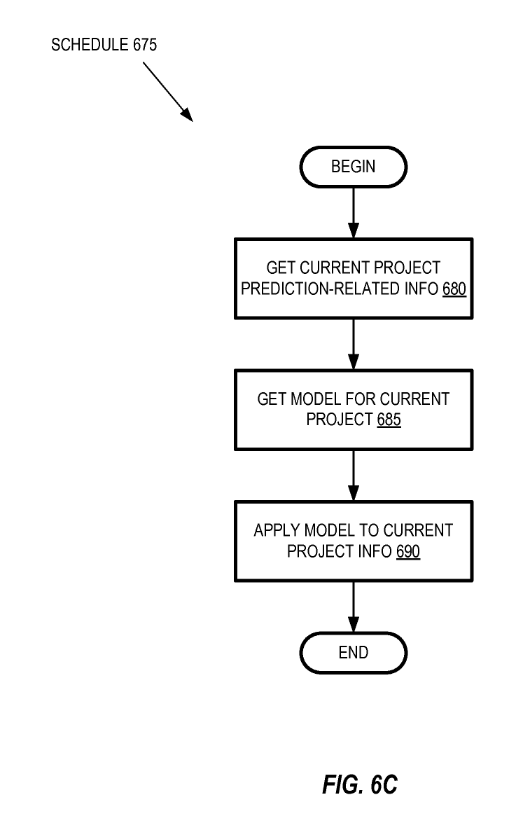

Referring now to FIG. 6A, information collecting processes 610 are illustrated according to embodiments of the present invention, wherein at 615 a stress level interface module measures stress levels and roles of project team members during performance of a product development project. This may include the interface sending questions about stress levels to project team members and receiving answers from project team members, which may be quantitative answers, which the interface stores. This includes storing which team member and which project each respective stress level measurement indicates.

Likewise, a project data interface module collects data at 620 from project records of the enterprise where the team members work, including i) time records, which indicate amount and nature of time each team member spent on the project, ii) milestones and iii) progress reports. Included in time records, progress reports, a combination of the two, or both, is information indicating, for each team member, time spent for respective milestones and work rate, i.e., relation of planned amount of progress versus amount of time spent on respective milestones. Note that roles may be included in project data, time records, or both, so that stress level interface may not need to request this information.

A computer implemented module at 630 monitors milestones for the project and upon each instance of completing a milestone at 640, the module updates tags 645 of stored stress level measures and other data that were collected by process 610 for an ongoing project, so that the updated tags indicate the data is now for a completed milestone, which may be a milestone indicating the project is completed.

Referring now to FIG. 6B, model development processes 650 are illustrated according to embodiments of the present invention, wherein at 655 a preprocessing module receives a request for modeling a current project and gets current project model-related information at 660, which includes identification of current team members. Also, at 665 preprocessing module gets selected information from past projects, which includes identification of team members of the current project, and past project roles, time records, milestones and progress reports for those team members, including times spent for respective milestones and work rates of the team members. The preprocessing module sends this information to a model development module, which responsively develops a model at 670 for the current project using answers to past stress level questionnaires, for example. Developing the model includes determining, for the past projects of the current team members, one or more relations between project milestone completion times and project team member stress levels, which includes one or more relation between work rates and project team member stress levels and indicates relative effects of respective team members on a work rate for the current project. This may include determining one or more relation between project milestone completion times and project team member roles, where completion times may be determined by work rates, as previously described herein. The model may determine a relation between work rate and stress level for a current project team member independent of team member roles. The model may then modify work rate responsive to the role of at least the one project team member or responsive to a whole set of roles for the set of team members.

It should be appreciated that aspects of the model may be developed before current project and before the request for a model for the current project. For example, work rate weighting factors may be determined for respective individuals based on their past projects even before it is known what individuals will be assigned to a current project. Then, when a request is made for a model for a current project, these parameters may be retrieved and used for the current model.

Referring now to FIG. 6C, processes 675 for scheduling a current project are illustrated according to embodiments of the present invention, wherein at 685 a current project module retrieves a model for the current project from a model development module and retrieves 680 prediction-related information for the current project, which includes stress level data for the respective team members, along with roles, time records, milestone definitions, which includes team member time that is planned for spending on each milestone, and progress reports for work that is underway for the current project. At 690 the current project module predicts time required for completion of a current milestone by applying the current stress levels of the current project team members to the determined relation between milestone completion times and project team member stress levels, which may include relation between work rates and project team member stress levels.

In embodiments of the present invention, there may be variations of what is described herein above. For example, stress levels may affect not only work rate but also work quality. Embodiments of the present invention may include a code review process for determining actual quality of the code, which may be compared to an ideal. So just as observations of actual work rate and parameters that affect work rate may be collected and compared to planned work rate to develop a model for predicting work rate, as described herein, likewise, observations of actual code quality and parameters that affect that may be collected and compared to planned code quality in order to develop a model for predicting code quality.

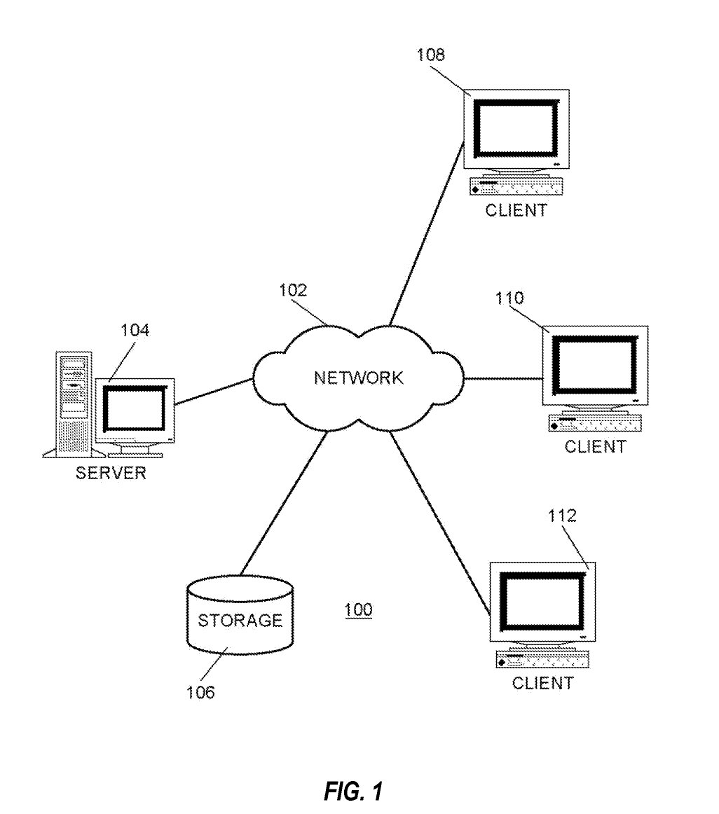

Regarding FIG. 1, a pictorial representation of a network data processing system 100 is shown in which the present invention may be implemented. Network data processing system 100 contains a network 102, which is the medium used to provide communications links between various devices and computers connected together within network data processing system 100. Network 102 may include connections, such as wire, wireless communication links, or fiber optic cables etc.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

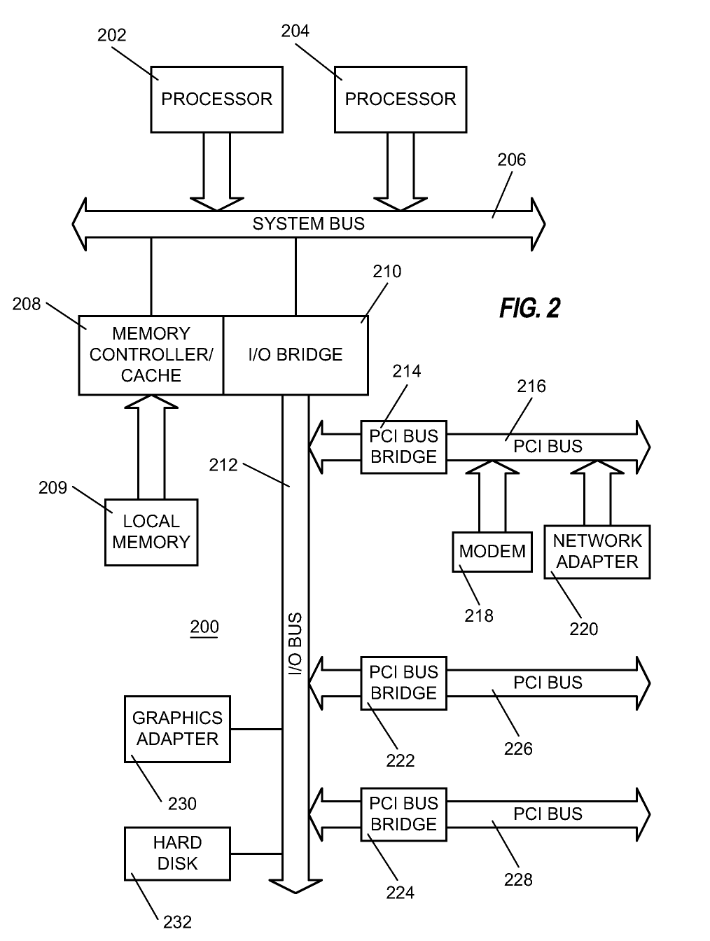

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support one or more PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM® eServer™ series system, running the IBM® AIX® operating system or LINUX® operating system. (IBM, eServer and AIXZ are trademarks of International Business Machines Corporation, registered in many jurisdictions worldwide. Linux is a registered trademark of Linus Torvalds in the United States, other countries, or both.)

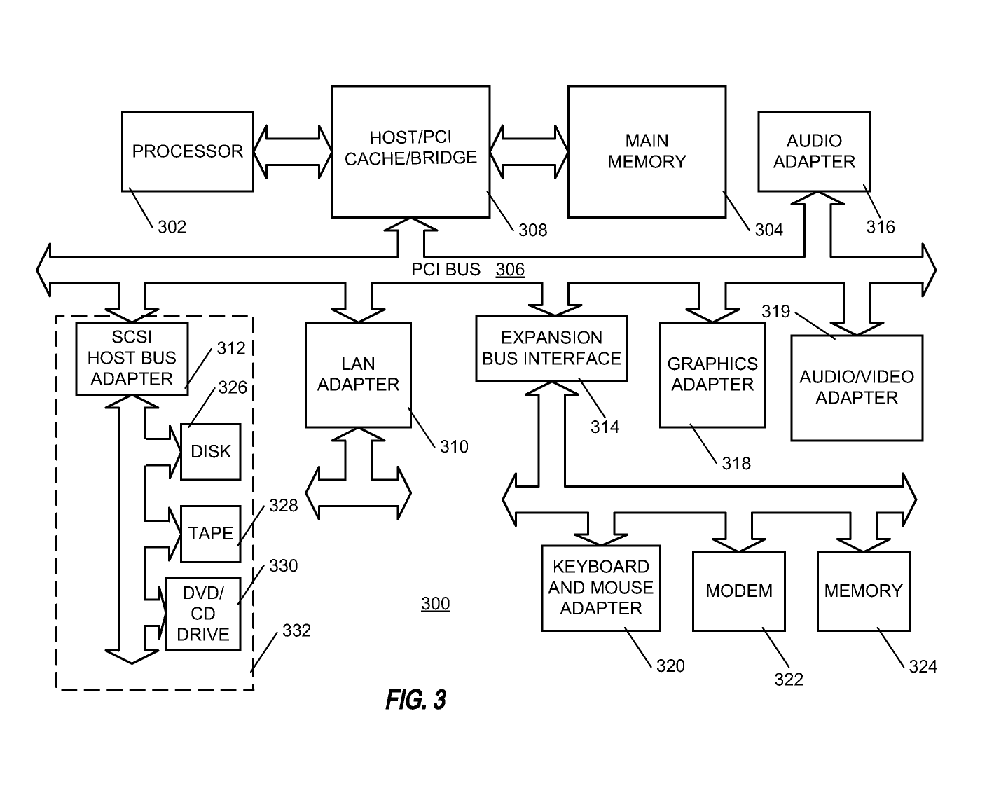

With reference now to FIG. 3, a block diagram illustrating a data processing system is depicted in which in an embodiment of the invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support a plurality of PCI expansion slots or add-in connectors.

An operating system runs on processor 302 and is used to coordinate and provide control of various components within data processing system 300 in FIG. 3. The operating system may be any available operating system (commercial or open source). An object oriented programming system may run in conjunction with the operating system and provide calls to the operating system from programs or applications executing on data processing system 300. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer as well as a PDA. Further, data processing system 300 may also be a kiosk or a Web appliance.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One or more databases may be included in a host for storing and providing access to data for the various implementations. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. A database product that may be used to implement the databases is IBM® DB2®, or other available database products. (IBM and DB2 are trademarks of International Business Machines Corporation, registered in many jurisdictions worldwide.) The database may be organized in any suitable manner, including as data tables or lookup tables.

The host may provide a suitable website or other internet-based graphical user interface accessible by users. In one embodiment, Netscape web server, IBM® Websphere® Internet tools suite, an IBM DB2, universal database platform and a Sybase database platform are used in conjunction with a Sun Solaris operating system platform. (IBM and WebSphere are trademarks of International Business Machines Corporation, registered in many jurisdictions worldwide.) Additionally, components such as JBDC drivers, IBM connection pooling and IBM MQ series connection methods may be used to provide data access to several sources. The term webpage as it is used herein is not meant to limit the type of documents and applications that might be used to interact with the user. For example, a typical website might include, in addition to standard HTML documents, various forms, applets, scripts, extensible markup language (XML), dynamic HTML, cascading style sheets (CSS), helper applications, plug-ins, and the like.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a key field in each of the manufacturer and retailer data tables. A key field partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

As used herein, the terms comprises, comprising, includes, including or any other variation thereof, are intended to cover a non-exclusive inclusion, such that a process, method, article, or apparatus that comprises a list of elements, for example, does not include only those elements but may include other elements not expressly listed or inherent to such process, method, article, or apparatus. Further, no element described herein is required for the practice of the invention unless expressly described as essential or critical.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

It should be appreciated that the particular implementations shown and described herein are illustrative of the invention and its best mode and are not intended to otherwise limit the scope of the present invention in any way. Other variations are within the scope of the following claims. Those skilled in the art having read this disclosure will recognize that changes and modifications may be made to the embodiments without departing from the scope of the present invention. While this specification contains many specifics, these should not be construed as limitations on the scope of the invention or of what can be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub combination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims.

What is claimed is:

1. A project scheduling method comprising:
measuring, by a computer implemented stress level interface, stress levels of project team members during performance of projects;
determining, by a computer implemented modeling module, a relation between project milestone completion times and project team member stress levels for past milestones based on the measured stress levels; and
predicting, by a computer implemented module, time required for completion of a milestone of the current project by applying the current stress levels of the current project team members to the determined relation between milestone completion times and project team member stress levels.

2. The method of claim 1, wherein the method further comprises:
measuring past work rates of past project team members, wherein the relation between milestone completion times and project team member stress levels includes a relation between work rates and project team member stress levels and wherein applying the current stress levels of the current project team members to the determined relation between milestone completion times and project team member stress levels comprises:
applying the current stress levels of the current project team members to the relation between work rates and project team member stress levels.

3. The method of claim 1, wherein the past project team members include the current project team members and wherein determining the relation between project milestone completion times and project team member stress levels comprises:
determining the relation based on stress levels for past projects of the current project team members.

4. The method of claim 1, wherein measuring stress levels of project team members during performance of projects includes:
presenting questions about stress levels to project team members; and
receiving quantitative answers from project team members, wherein the quantitative answers are used for determining the relation between project milestone completion times and project team member stress levels.

5. The method of claim 1, wherein the relation indicates relative effects of respective team members on a work rate for the current project.

6. The method of claim 1, comprising:
determining roles of past project team members; and
determining for past projects a relation between project milestone completion times and project team member roles.

7. The method of claim 2, comprising:
determining roles of past project team members; and
modifying the relation between work rate and stress level for at least one project team member, wherein the modifying is responsive to the role of the at least one project team member.

8. A system for project scheduling, comprising:
a processor; and
a computer readable storage medium connected to the processor, wherein the computer readable storage medium has stored thereon a program for controlling the processor, and wherein the processor is operative with the program to execute the program for:
measuring, by a computer implemented stress level interface, stress levels of project team members during performance of projects;
determining, by a computer implemented modeling module, a relation between project milestone completion times and project team member stress levels for past milestones based on the measured stress levels; and
predicting, by a computer implemented module, time required for completion of a milestone of the current project by applying the current stress levels of the current project team members to the determined relation between milestone completion times and project team member stress levels.

9. The system of claim 8, wherein the processor is operative with the program to execute the program for:
measuring past work rates of past project team members, wherein the relation between milestone completion times and project team member stress levels includes a relation between work rates and project team member stress levels and wherein applying the current stress levels of the current project team members to the determined relation between milestone completion times and project team member stress levels comprises:
applying the current stress levels of the current project team members to the relation between work rates and project team member stress levels.

10. The system of claim 8, wherein the past project team members include the current project team members and wherein determining the relation between project milestone completion times and project team member stress levels comprises:
determining the relation based on stress levels for past projects of the current project team members.

11. The system of claim 8, wherein measuring stress levels of project team members during performance of product development projects includes:
presenting questions about stress levels to project team members; and
receiving quantitative answers from project team members, wherein the quantitative answers are used for determining the relation between project milestone completion times and project team member stress levels.

12. The system of claim 8, wherein the relation indicates relative effects of respective team members on a work rate for the current project.

13. The system of claim 8, wherein the processor is operative with the program to execute the program for:
determining roles of past project team members; and
determining for past projects a relation between project milestone completion times and project team member roles.

14. The system of claim 8, wherein the processor is operative with the program to execute the program for:
determining roles of past project team members; and
modifying the relation between work rate and stress level for at least one project team member, wherein the modifying is responsive to the role of the at least one project team member.

15. A computer program product for project scheduling, the computer program product including a computer readable storage medium having instructions stored thereon for execution by a computer system, wherein the instructions, when executed by the computer system, cause the computer system to implement a method comprising:
measuring, by a computer implemented stress level interface, stress levels of project team members during performance of projects;
determining, by a computer implemented modeling module, a relation between project milestone completion times and project team member stress levels for past milestones based on the measured stress levels; and
predicting, by a computer implemented module, time required for completion of a milestone of the current project by applying the current stress levels of the current project team members to the determined relation between milestone completion times and project team member stress levels.

16. The computer program product of claim 15, wherein the instructions, when executed by the computer system, cause the computer system to implement a method further comprising:
measuring past work rates of past project team members, wherein the relation between milestone completion times and project team member stress levels includes a relation between work rates and project team member stress levels and wherein applying the current stress levels of the current project team members to the determined relation between milestone completion times and project team member stress levels comprises:
applying the current stress levels of the current project team members to the relation between work rates and project team member stress levels.

17. The computer program product of claim 15, wherein the past project team members include the current project team members and wherein determining the relation between project milestone completion times and project team member stress levels comprises:
determining the relation based on stress levels for past projects of the current project team members.

18. The computer program product of claim 15, wherein measuring stress levels of project team members during performance of projects includes:
presenting questions about stress levels to project team members; and
receiving quantitative answers from project team members, wherein the quantitative answers are used for determining the relation between project milestone completion times and project team member stress levels.

19. The computer program product of claim 15, wherein the relation indicates relative effects of respective team members on a work rate for the current project.

20. The computer program product of claim 15, wherein the instructions, when executed by the computer system, cause the computer system to implement a method further comprising:
determining roles of past project team members; and
determining for past projects a relation between project milestone completion times and project team member roles.
